(19) United States
(12) Patent Application Publication
(10) Pub. No.: US 2009/0284469 A1
(43) Pub. Date: Nov. 19, 2009

(54) VIDEO BASED APPARATUS AND METHOD FOR CONTROLLING THE CURSOR

(75) Inventors: Chen-Chiung Hsieh, Taipei City (TW); Tung-Hua Liu, Keelung City (TW); Ming-Hsien Lien, Taipei County (TW); Kuo-Hua Lo, Taipei County (TW); Hsiang-Min Yu, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignees: TATUNG COMPANY, Taipei (TW); TATUNG UNIVERSITY

(21) Appl. No.: 12/138,448

(22) Filed: Jun. 13, 2008

(30) Foreign Application Priority Data
May 16, 2008 (TW) 97118232

(51) Int. Cl. G06F 3/033

(52) U.S. Cl. 345/158

(57) ABSTRACT

A video-based apparatus and method for controlling the cursor are provided. A video camera is used to acquire a hand image of a user, and then the image is analyzed and processed to move the cursor and to take place of functions of a mouse left button and a mouse right button. The user may use a “V” shaped hand gesture to replace the mouse. An index finger image is corresponding to the mouse left button, and a middle finger image is corresponding to the mouse right button. A valley point of the “V” shaped hand gesture is corresponding to the position of the cursor.

### CROSS-REFERENCE TO RELATED APPLICATION

This application claims the priority benefit of Taiwan application serial no. 97118232, filed on May 16, 2008. The entirety of the above-mentioned patent application is hereby incorporated by reference herein and made a part of specification.

### BACKGROUND OF THE INVENTION

1. Field of the Invention

The present invention relates to an apparatus using a video camera to replace a mouse, in particular, to an apparatus and a method for controlling a cursor using the hand gestures to replace the mouse.

2. Description of Related Art

In recent years, the information technology has been developed rapidly, various information products such as cell phones, computers, and personal digital assistants (PDAs) have been widely used everywhere. With their help, the essential requirements of the mass in terms of food, clothing, housing, transportation, education, and entertainment in daily life can be satisfied. Accordingly, people increasingly rely on the information products, and they have become an indispensable part of people's daily life.

The mouse, as one of the essential peripheral devices of the computer, is used to control the moving of the cursor and the click of an object. However, as for notebook computers or mobile electronics such as cell phones, it is rather inconvenient to additionally carry the mouse. Currently, the touch pad and/or stylus have been developed to replace the mouse. However, merely small-sized touch pads are installed to match with the cell phones, which are not easily operated, and the touch panels for computers or notebook computers are quite expensive due to the large size, which are not popular currently.

### SUMMARY OF THE INVENTION

The present invention is directed to a video-based apparatus and method for controlling a cursor, which uses a video frame of a “V” shaped hand gesture to replace the mouse left and right buttons and to control the movement of the cursor. The present invention can replace the mouse and control the cursor, merely through disposing an image-capturing device like a video camera, thereby improving the convenience in operating the electronic apparatus.

The “V” shaped hand gesture image includes a first finger image and a second finger image which form a “V” shape. The present invention further provides an apparatus for controlling a cursor, which moves the cursor according to a hand image, and determines whether to click a mouse left button, a mouse right button, or double-click a mouse left button. The first finger image is corresponding to the mouse left button, the second finger image the mouse right button, and a valley part of the “V” shape formed by the first finger image and the second finger image is corresponding to the position of the cursor.

Accordingly, the present invention provides an apparatus for controlling a cursor, which includes an image capturing unit, an image processing unit, and a cursor display and button control unit. The image capturing unit receives a hand image of a user. The image processing unit is coupled to the image capturing unit, for determining whether a “V” shaped hand gesture appears or not, and if yes, three feature points of the “V” shape are extracted, which are corresponding to coordinates of the cursor, a mouse left button, and a mouse right button. According to a preset moving speed of the cursor, the cursor display and button control unit calculates the next position for displaying the cursor depending upon the continuously extracted corresponding cursor coordinates from continuous images, and displays whether the button signal is sent or not.

In an embodiment of the present invention, a motion that the user bends a finger corresponding to the first finger image indicates clicking the mouse left button. A motion that the user bends a finger corresponding to the second finger image indicates clicking the mouse right button. The first finger and the second finger are respectively an index finger and a middle finger, or vice versa.

In an embodiment of the present invention, a motion that the user bends both fingers respectively corresponding to the first finger image and the second finger image indicates double-clicking the mouse left button.

In an embodiment of the present invention, the image processing unit determines whether the hand image presents the “V” shaped hand gesture or not according to a vertical projection of the hand image. The valley part of the “V” shaped hand gesture is corresponding to the coordinates of the cursor, and two vertexes are corresponding to the mouse left button and the mouse right button.

In an embodiment of the present invention, the apparatus for controlling the cursor further takes a length variation of the vertex position of the first finger image to indicate whether the mouse left button is clicked or not, and takes a length variation of the vertex position of the second finger image to indicate whether the mouse right button is clicked or not.

The present invention provides a method for controlling a cursor, which includes the following steps. First, a hand image of a user is captured. Next, a background removal is performed to extract a motion area. Then, a skin color detection is performed on the motion area to extract the hand image area. Then, it is determined whether the hand image presents the “V” shaped hand gesture or not. The three feature points of the “V” shape are respectively corresponding to coordinates of the cursor, a mouse left button, and a mouse right button. If the hand image includes a first finger image, a second finger image, and a valley part of the “V” shape formed there-between, the cursor, the mouse left button, and the mouse right button are respectively controlled according to the three feature points. The first finger image is corresponding to the mouse left button, the second finger image is corresponding to the mouse right button, the position variation of the valley part of the “V” shape formed between the first finger image and the second finger image is corresponding to the position of the cursor.

In an embodiment of the present invention, the step of performing the skin color detection on the motion area to extract the hand image area further includes filtering image noises, removing burrs, and repairing holes.

In an embodiment of the present invention, the step of performing the “V” shaped hand gesture detection to extract the features of the hand image further includes detecting according to a vertical projection of the hand image, in which if two vertexes and a valley formed there-between are detected, it indicates that the features of the hand image appear.

In an embodiment of the present invention, the above method further includes: a motion that the user bends a first finger corresponding to the first finger image indicates clicking the mouse left button, and a motion that the user bends a second finger corresponding to the second finger image indicates clicking the mouse right button. The first finger and the second finger are respectively an index finger and a middle finger, or vice versa.

In an embodiment of the present invention, the above method further includes: when the user moves the hand image, the cursor is moved correspondingly according to the position variation of the valley point of the “V” shape.

The present invention adopts a video frame of a hand gesture to replace the mouse, so that the user can operate the cursor and click the mouse left button and the mouse right button simply through using the gesture, which brings conveniences in using electronic apparatuses. Furthermore, the present invention replaces the mouse merely through utilizing video functions widely adopted by the current electronic apparatuses (e.g., cell phones or notebook computers). Therefore, in most consumer electronic products, the technical means of the present invention can be achieved, without increasing the cost of additional hardware.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of functions of an apparatus for controlling a cursor according to a first embodiment of the present invention.

FIG. 2 is a schematic view of gestures of a user according to the first embodiment of the present invention.

FIG. 3 is a contrast diagram of a hand image and an operation of a mouse left button and a mouse right button according to the first embodiment of the present invention.

FIG. 4 is a schematic view of an application in a cell phone according to the first embodiment of the present invention.

FIG. 5 is a schematic flow chart of a method for controlling a cursor according to a second embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

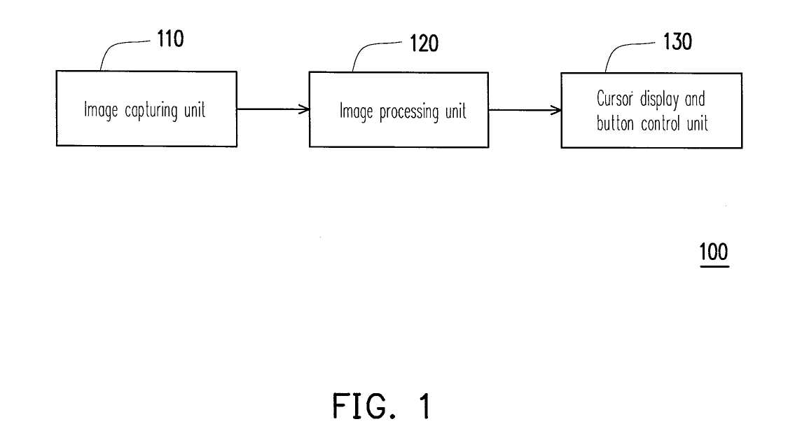

FIG. 1 is a block diagram of functions of an apparatus for controlling a cursor according to a first embodiment of the present invention. Referring to FIG. 1, an apparatus 100 for controlling a cursor includes an image capturing unit 110, an image processing unit 120, and a cursor display and button control unit 130. The image processing unit 120 is coupled between the image capturing unit 110 and the cursor display and button control unit 130. The image capturing unit 110 is, for example, an image receiving apparatus, such as a web camera and a camera device in a cell phone. The cursor display and button control unit 130 is, for example, used for calculating a continuous moving distance of the cursor and determining whether the button signal is sent or not through a display device such as an LCD and a screen in the cell phone.

The image capturing unit 110 receives a hand image of a user. The image processing unit 120 processes and distinguishes the hand image to extract features of the hand image, and determines whether the hand image of the user contains the “V” shaped hand gesture or not, in which three feature points of the “V” shaped hand gesture are respectively corresponding a position of the cursor, a mouse left button, and a mouse right button.

The above three feature points of the “V” shaped hand gesture are respectively a first finger image, a second finger image, and a valley point of the “V” shape formed there-between. The first finger image is corresponding to the mouse left button, the second finger image is corresponding to the mouse right button, and a position variation of the valley point of the “V” shape formed between the first finger image and the second finger image is corresponding to the position of the cursor. The first finger image and the second finger image are respectively formed by a middle finger and an index finger (or vice versa). The “V” shape hand image is, for example, a victory gesture. When the hand image of the user is the “V” shaped hand gesture, the cursor display and button control unit 130 moves the cursor and operates the mouse left and right buttons according to the gesture of the user.

The image processing includes background removal, skin color detection, noise filtering, vertical projection, and feature point extracting, and so on. The background removal includes taking the first image as a background, and subtracting the first image from the next image to obtain a motion area. The skin color detection utilizes color coordinates HSV (Hue, Saturation, Value) to perform the skin color detection on the motion area, so as to avoid detection errors caused by the human face that appears in the image, and the processing speed is improved. The noise filtering includes removing burrs and repairing small holes through dilation and erosion. The detection of the “V” shaped hand gesture image is achieved by distinguishing the features of two vertexes and a valley formed there-between on the vertical projection.

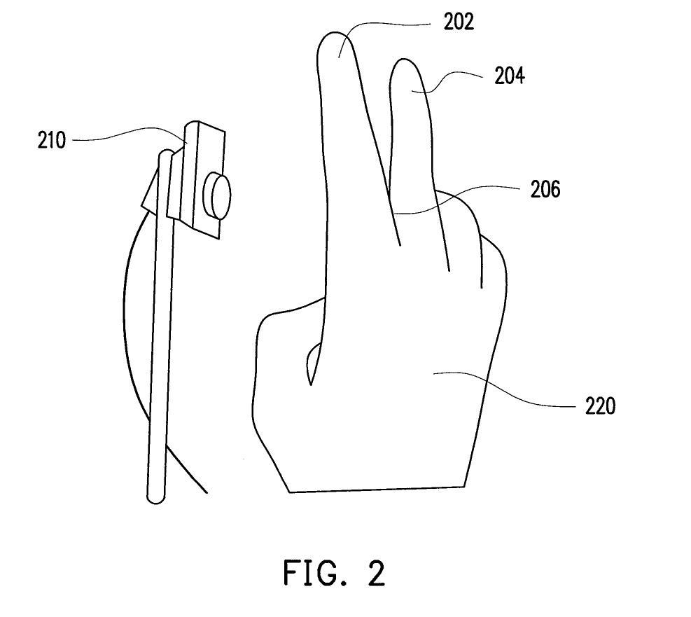

Then, FIG. 2 is a schematic view of gestures of a user according to the first embodiment of the present invention. Referring to FIG. 2, the web camera 210 is the image capturing unit, which may be connected to an electronic apparatus such as the computer, notebook computer, or cell phone, to capture a hand image of a user. The user makes a “V” shape (victory) gesture with the hand 220. The index finger 202 produces the first finger image, and the middle finger 204 produces the second finger image. The index finger 202 is corresponding to the mouse left button, and the middle finger 204 is corresponding to the mouse right button. A bottom part 206 (a junction between the index finger 202 and the middle finger 204, i.e., the valley part of the “V” shaped hand gesture) of the index finger 202 and the middle finger 204 is corresponding to the position of the cursor. When the user moves the hand, the image processing unit 120 moves the cursor correspondingly according to the movement of the bottom part 206.

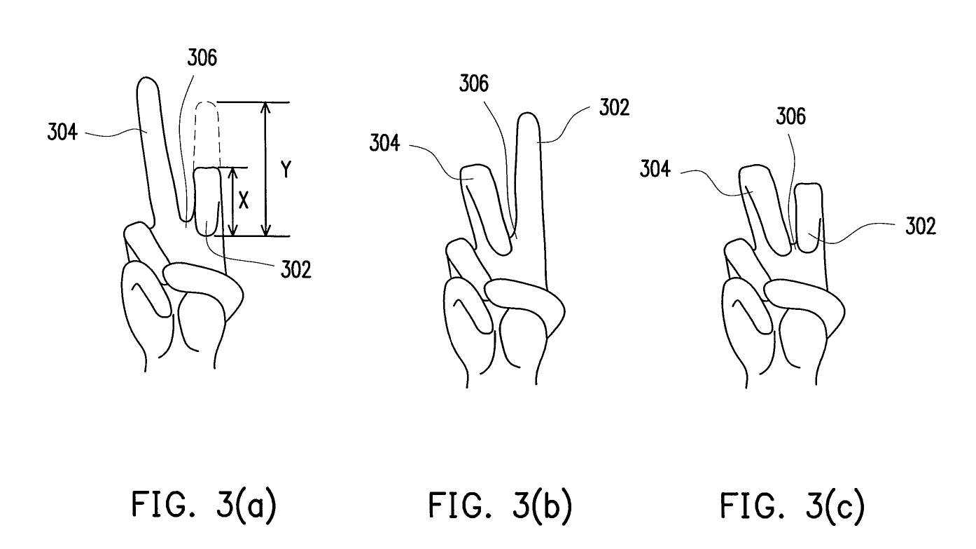

A corresponding relation between hand images and operations of the mouse left button and the mouse right button is shown in FIG. 3. FIG. 3 is a contrast diagram of a hand image and an operation of a mouse left button and a mouse right button according to the first embodiment of the present invention. The motion that the user merely bends the index finger 202 corresponding to first finger image 302 indicates clicking the mouse left button, as shown in FIG. 3(a). The motion that the user merely bends the middle finger 204 corresponding to the second finger image 304 indicates clicking the mouse right button, as shown in FIG. 3(b). The motion that the user bends both the index finger 202 and the middle finger 204 indicates double-clicking the mouse left button. At this time, both the first finger image 302 and the second finger image 304 are bent correspondingly, as shown in FIG. 3(c).

The length variation of the finger image is directly used to determine whether the finger is bent or not. When the user bends the finger, the length of the vertically-projected finger image becomes shorter, as shown in FIG. 3(a), the length of the finger image 302 is changed to X from Y, and so forth. When the user moves the hand 220, the image processing unit 120 moves the cursor correspondingly according to the movement of the bottom part 306 formed between the first finger image 302 and the second finger image 304.

In view of the above, this embodiment utilizes the video frames of the “V” shaped hand gesture to replace the functions of the mouse to control the cursor, and utilizes the length variations of the vertex positions of the index finger and the middle finger to determine whether to click the mouse left button or the mouse right button, or double-click the mouse left button. The user uses the hand motions to take place of the mouse to operate the cursor, and thus achieving the effect of clicking the mouse left button and the mouse right button or double-clicking the mouse left button. Definitely, the corresponding relation between the fingers and the mouse left button and the mouse right button can be modified through setting, so as to cater to the left-handed users. In terms of the signal transmission of the mouse, a mouse_event in an MSDN function database corresponding to signals in operating the mouse is used to provide functions of moving the mouse and clicking the buttons.

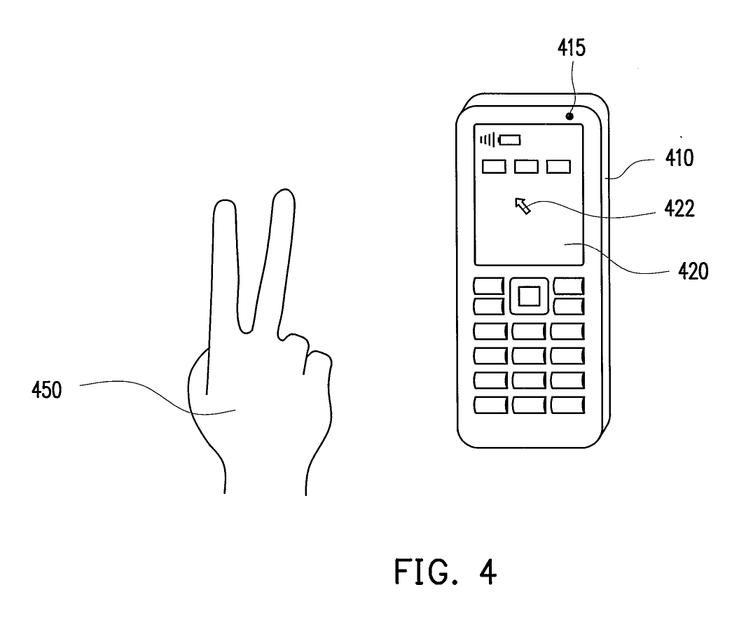

Furthermore, it should be noted that, this embodiment may be directly applied in most of the consumer electronic products, e. g., cell phones. FIG. 4 is a schematic view of an application in a cell phone according to this embodiment. As shown in FIG. 4, the cell phone 410 includes a screen 420 and a camera device 415. The screen 420 is used to display a cursor 422. When the user makes a “V” shaped hand gesture with the hand 450, the cell phone 410 utilizes the movement and motion of the user's hand 450 to take place of the mouse, so as to achieve the functions of operating the cursor and clicking the mouse. The image processing motions of the image processing unit 120 may be directly replaced by a built-in processor in the cell phone 410. Other detailed operations of FIG. 4 can be obtained with reference to the illustrations about FIGS. 1 to 3, which will not be described herein again.

### Second Embodiment

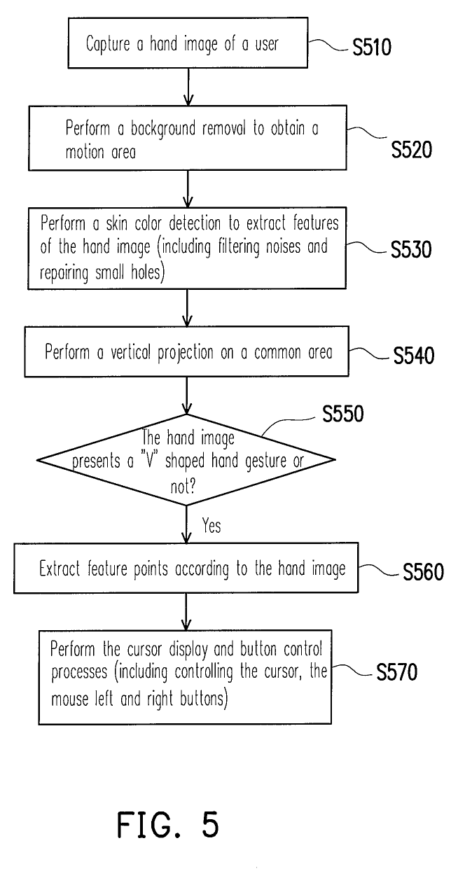

In view of the above, the present invention provides a method for controlling a cursor. FIG. 5 is a schematic flow chart of a method for controlling a cursor according to a second embodiment of the present invention.

First, a hand image of a user is captured (Step S510). Next, a background removal is performed (Step S520), so as to obtain a motion area. Then, a skin color detection is performed to extract a hand image area (Step S530). In Step S530, the processes of filtering noises and repairing small holes are further included. Then, a vertical projection is performed on a common area serving as both the motion area and the skin color area (Step S540). Thereafter, it is detected whether the “V” shaped hand gesture appears or not (Step S550), and if yes, a projection shape of two vertexes and a valley formed there-between is formed to extract three feature points of the “V” shaped hand gesture (Step S560). The above three feature points are respectively a first finger image, a second finger image, and a valley part of the “V” shape formed there-between, which are respectively corresponding to the coordinates of the cursor, the mouse left button, and the mouse right button. Then, according to the extracted feature points, the cursor display and button control processes are performed, which include moving the cursor, controlling the mouse left button and the mouse right button, and the like (Step S570).

The first finger image in the “V” shaped hand gesture is corresponding to the mouse left button. The second finger image is corresponding to the mouse right button. The position variation of the valley part of the “V” shape formed between the first finger image and the second finger image is corresponding to the position of the cursor (coordinates of the cursor). Other details about the method of the present invention can be obtained with reference to the illustrations about the first embodiment.

To sum up, the present invention utilizes the image processing technique to use the user's hand gesture to replace the mouse, which enables the user to directly use the “V” shaped hand gesture to move the cursor, click the mouse left button and the mouse right button, and the like. When operating the computer or playing games, the user performs operations directly using his/her hands, like Wii, to achieve more enjoyable entertainment effects. Therefore, the present invention brings conveniences in operating electronic apparatuses, and meanwhile saves the cost for purchasing the mouse or touch pad. Furthermore, the present invention can be directly applied in electronic apparatuses with camera devices, such as cell phones and computers, without requiring any additional hardware. Meanwhile, the operation function of the electronic apparatus itself can be directly used to achieve the image distinguishing and mouse driving effects, which has the commercial value in terms of industrial application.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for controlling a cursor, comprising:
an image capturing unit, for receiving a hand image of a user; and
an image processing unit, coupled to the image capturing unit, for extracting features of the hand image, and determining whether the hand image presents a “V” shaped hand gesture or not, and if yes, three feature points of the “V” shaped hand gesture are respectively corresponding to coordinates of a cursor, a mouse left button, and a mouse right button,
wherein the three feature points of the “V” shaped hand gesture comprises a first finger image, a second finger image, and a valley point of a “V” shape formed there-between, the image processing unit controls the cursor, the mouse left button, and the mouse right button according to the extracted three feature points of the “V” shaped hand gesture, wherein the first finger image is corresponding to the mouse left button, the second finger image is corresponding to the mouse right button, a position variation of the valley part of the “V” shape formed by the first finger image and the second finger image is corresponding to a position of the cursor.

2. The apparatus for controlling the cursor according to claim 1, wherein a length variation of a vertex position of the first finger image indicates whether the mouse left button is clicked or not, and a length variation of a vertex position of the second finger image indicates whether the mouse right button is clicked or not.

3. The apparatus for controlling the cursor according to claim 1, wherein a motion that the user bends a first finger corresponding to the first finger image indicates clicking the mouse left button, and a motion that the user bends a second finger corresponding to the second finger image indicates clicking the mouse right button.

4. The apparatus for controlling the cursor according to claim 1, wherein a motion that the user bends both a first finger and a second finger respectively corresponding to the first finger image and the second finger image indicates double-clicking the mouse left button.

5. The apparatus for controlling the cursor according to claim 1, wherein the first finger image is corresponding to an index finger of the user, and the second finger image is corresponding to a middle finger of the user.

6. The apparatus for controlling the cursor according to claim 1, wherein the first finger image is corresponding to a middle finger of the user, and the second finger image is corresponding to an index finger of the user.

7. The apparatus for controlling the cursor according to claim 1, wherein the image processing unit further determines whether the hand image presents the “V” shaped hand gesture or not according to a vertical projection of the hand image, and the three feature points thereof are respectively corresponding to the coordinates of the cursor, the mouse left button, and the mouse right button.

8. The apparatus for controlling the cursor according to claim 1, further comprising a cursor display and button control unit for displaying the cursor and determining whether a button signal is sent or not.

9. A method for controlling a cursor, comprising:
capturing a hand image of a user;
performing a background removal to extract a motion area;
performing a skin color detection on the motion area to extract a hand image area and to filter noises;
performing a vertical projection to determine whether the hand image presents a “V” shaped hand gesture or not; and
if the hand image contains the “V” shaped hand gesture, extracting three feature points of the “V” shaped hand gesture, and controlling a cursor, a mouse left button, and a mouse right button according to the three feature points of the “V” shaped hand gesture,
wherein the three feature points of the “V” shaped hand gesture comprise a first finger image, a second finger image, and a valley part of a “V” shape formed there-between, the first finger image is corresponding to the mouse left button, the second finger image is corresponding to the mouse right button, and a position variation of the valley part of the “V” shape formed between the first finger image and the second finger image is corresponding to a position of the cursor.

10. The method for controlling a cursor according to claim 9, wherein the step of performing a skin color detection on the motion area to extract a hand image area and to filter noises further comprises a background removal, a noise filtering, and an image repair process.

11. The method for controlling a cursor according to claim 9, wherein the step of determining whether the hand image presents a “V” shaped hand gesture or not further comprises determining whether there is a feature of two vertexes and a valley formed there-between or not according to the vertical projection of the hand image.

12. The method for controlling a cursor according to claim 9, wherein
a motion that the user bends a first finger corresponding to the first finger image indicates clicking the mouse left button; a motion that the user bends a second finger corresponding to the second finger image indicates clicking the mouse right button; and a motion that the user bends both the first finger and the second finger respectively corresponding to the first finger image and the second finger image indicates double-clicking the mouse left button.

13. The method for controlling a cursor according to claim 9, further comprising:
when the user moves the hand image, moving the cursor correspondingly according to the position variation of the valley part of the “V” shape.

14. The method for controlling a cursor according to claim 9, wherein the first finger image is corresponding to an index finger of the user, and the second finger image is corresponding to a middle finger of the user.

15. The method for controlling a cursor according to claim 9, wherein the first finger image is corresponding to a middle finger of the user, and second finger image is corresponding to an index finger of the user.
